(19) United States
(12) Patent Application Publication
(10) Pub. No.: US 2008/0273240 A1
(43) Pub. Date: Nov. 6, 2008

(54) Infrared Radiation Absorbing Sun Protection Film

(75) Inventors: Anne Danzebrink, St. Ingsert (DE); Detlef Burgard, Volklingen (DE)

Correspondence Address: HARNESS, DICKEY & PIERCE, P.L.C., P.O. BOX 828, BLOOMFIELD HILLS, MI, 48303, US

(73) Assignee: AIR PRODUCTS AND CHEMICALS, INC., Allentown, PA (US)

(21) Appl. No.: 11/720,198

(22) PCT Filed: Nov. 28, 2005
(86) PCT No.: PCT/EP05/56251

§ 371 Date: Jul. 21, 2008

Related U.S. Application Data
(60) Provisional application No. 60/648,610, filed on Jan. 31, 2005.

(30) Foreign Application Priority Data
Dec. 3, 2004 (EP) 04028706

(51) Int. Cl. G02B 5/22; G02B 1/04

(52) U.S. Cl. 359/359

(57) ABSTRACT

The invention pertains to a colored sun protection film for transparent or translucent glazings having at least a metallized and/or non-metallized supporting film and at least one functional layer.

### FIELD

The invention pertains to a sun protection film for transparent or translucent glazings having at least one metallized and/or non-metallized supporting layer and at least one functional layer.

### BACKGROUND

Normal glass will allow not only light, but also heat to enter the room. This heat is often considered disagreeable, e.g., in vehicles.

With real estate, mainly glazings facing the sun are problematic. Here, sun protection glazings or sun protection systems (exterior sunblinds, awnings and sun protection films) provide protection to block the solar energy and hence the heat already at the glass system.

A film is the sun protection system changing the overall appearance of buildings or vehicles to the lowest extent and surely the cheapest solution.

The known sun protection films are self-adhesive transparent polyester films with various metal coatings which are applied to glass surfaces and considerably reduce the strong incident heat radiation and the glare caused by the sun. They act as a reflecting protective shield. Sun protection films are used everywhere where glares and temperature rises may be induced by glass surfaces in windows and doors or overhead glazings. The room or vehicle climate becomes much more even and thus more comfortable. Usually, the supporting material is a polyester film with an optically clear metal vapor coating or sputter coating and provided with an adhesive. Typically, sun protection films are chemically resistant to alcohol, hydrocarbons, ketones, esters, alkalis and diluted acids.

A common uniform aluminium vapor deposited coating reflects the irradiating solar energy and allows high-contrast, damped light to enter. Sun protection films reduce ultraviolet radiation and may hence delay bleaching processes. In case of glass breakage, the sun protection film increases safety by binding glass splinters.

Typically, the following measuring quantities are used to characterize sun protection films:

The light transmittance is normally measured according to DIN EN 410 in a range of from 380 to 780 nm (DN 65) and is normally below 40% for sun protection films.

The total energy transmission g is usually measured according to DIN 4108-3 and is normally below 1 for sun protection films.

The light transmission (VLT) is typically measured according to DIN 67507 in % and is normally below 40% for sun protection films. In the US, however, a VLT value of at least 35% is required by law.

The selectivity constant is the quotient of light transmission and total energy transmission and is normally below 1 for sun protection films.

The luminous reflectance is usually measured according to the mark DIN 5036-3 (400-700) and is normally greater than 70% for sun protection films.

The chromaticity (chroma value) is defined as C* (CIELAB system, corresponding to the square root of the sum (a²+b²); a, b: measured values of the yellow and the blue shift, resp., based on white; C*=“chromaticity”) and is normally greater than 5 for sun protection films.

The shading coefficient is defined as the total energy transmission g divided by the total energy transmission g of a glass plate having a thickness of 3 cm, the total energy transmission of the latter being defined as 0.87.

Typically, the supporting films consist of PET and have a thickness of from 0.5 to 1 mm. At least in the field of vehicles, the width of the supporting films is usually 155 cm or greater.

U.S. Pat. No. 6,383,625 B1 describes a sun protection film having a silicone resin in the functional layer thereof.

WO 03/050193 A1 describes an infrared absorbing material which results in a color tone being within a range of x values of from 0.220 to 0.205 and within a range of y values of from 0.235 to 0.325 in an x/y color scale.

EP 1008564 A1 describes an infrared radiation absorbing material containing hexaborides.

U.S. Pat. No. 6,191,884 B1 describes an infrared radiation absorbing film wherein the matrix of the film consists of a photocationically formed polymer.

U.S. Pat. No. 6,261,684 B1 describes an infrared radiation absorbing film wherein the infrared radiation absorbing layer may comprise ITO in a range of from 60 to 90% by weight.

JP 07100996 A describes an infrared radiation absorbing film wherein one layer contains organic infrared radiation absorbing materials and another layer contains inorganic infrared radiation absorbing materials.

EP 1823107 A2 describes a coating having a primer layer.

### SUMMARY

It is the object of the present invention to provide a sun protection film having good performance and fitting properties which does not cause additional reflections.

### DRAWINGS

The drawings described herein are for illustration purposes only and are not intended to limit the scope of the present disclosure in any way.

FIG. 1 is a graph depicting the transmission percent versus wavelength for a first comparative example;

FIG. 2 is a graph depicting the transmission percent versus wavelength for a first example according to the teachings of the present invention;

FIG. 3 is a graph depicting the transmission percent versus wavelength for a second comparative example; and

FIG. 4 is a graph depicting the transmission percent versus wavelength for a second example according to the teachings of the present invention.

### DETAILED DESCRIPTION

In a first embodiment the object of the invention is attained by a sun protection film for transparent or translucent glazings having a transmission at a wavelength of 1000 nm of up to 50% of the maximum value of the transmission in the wavelength range below 1000 nm comprising:

a) at least one metallized or non-metallized supporting film which has a thickness of from 0.1 to 500 μm and planarly contacts at least one adhesive layer and

b) at least one functional layer which contains an organic infrared radiation absorbing material on at least one main surface of the supporting film and which contains metal, is metallic or metal-free and
i) contains pigment and/or colorants,
ii) contains at least one UV radiation absorbing material and/or
iii) has a pencil hardness of at least 3H.

Here, the supporting film (without the adhesive layer) has a layer thickness in a range of from 0.1 to 500 μm.

The glazing within the meaning of the present invention comprises in particular real estate glazings, vehicle glasses (passenger car, truck, airplane, tram, busses, . . . ) and glass surfaces in the interior of real estate where a special heat insulation is required.

Preferably, the sun protection film has at least two functional layers with each functional layer differing from the adjacent functional layer by at least one property i) to iii) and only one of said layers containing an organic infrared radiation absorbing material.

Since the transmission in the near infrared region (e.g., at 1000 nm) is lower as compared to the state of the art, the films according to the invention may provide a good heat insulation despite a comparatively low coloring. While with known films a substantial amount of colorant had to be incorporated to achieve an efficient heat insulation, said colorant distinctly reducing also the visible transmission, with the sun protection films according to the invention a low transmission in the near infrared region may be achieved despite a low coloring. Advantageously, the transmission at a wavelength of incident light of 1000 nm is at most 10% of the maximum transmission of the sun protection film.

Preferably, the sun protection film comprises an adhesive layer for the mounting of the supporting layer. Accordingly, said adhesive layer is an outer layer of the sun protection film used for the planar attachment on the glazing.

Preferably, the sun protection film according to the invention does not have a separate primer layer. Hence, an additional process step may be omitted and a cheaper production be designed.

The layer thickness of the complete sun protection film is preferably in a range of from 5 to 550 μm, in particular in a range of from 5 to 200 μm.

Preferably, the functional layer and/or the supporting film may comprise colorants, pigments, in particular metal particles such as silver particles or carbon black. Furthermore, the supporting layer and/or the functional layer may preferably contain UV absorbing agents to improve the stability against light irradiation.

### Functional Layer

Preferably, the functional layer matrix predominantly consists of a polymer selected from the group of polyacrylate, PMMA, polyvinylpyrrolidone (PVP), polyvinyl butyral (PVB), polyvinyl alcohols (PVA), polyethylene glycols, polyurethanes, bisphenol-based polymers, polyepoxides, siloxane-based polymers and/or polyesters. Said polymers may preferably be homopolymers or copolymers or blends of the homopolymers and/or copolymers of monomers selected from the group or vinyl monomers, acrylates and epoxides. Equally preferred UV-crosslinking materials are used as matrix material. Especially preferred polyacrylate or copolymers containing acrylates are used.

As the starting component for the polyurethanes according to the invention aliphatic, cycloaliphatic, araliphatic, aromatic and heterocyclic polyisocyanates are suited which have been described, e.g., by W. Siefken in Justus Liebigs Annalen der Chemie, 562, p. 75 to 136, e.g., those of the formula Q(NCO)ₙ

wherein n=2 to 4, Q is an aliphatic hydrocarbon moiety having from 2 to 18, preferably from 6 to 10 C atoms, a cycloaliphatic hydrocarbon moiety having from 4 to 15, preferably from 5 to 10 C atoms, an aromatic hydrocarbon moiety having from 6 to 15, preferably from 6 to 13 C atoms, or an aliphatic hydrocarbon moiety having from 8 to 15, preferably from 8 to 13 C atoms, e.g., ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3- and -1,4-diisocyanate and any blends of these isomers, 1-isocyanato-3,3,5-trimethyl-5-isocyanatomethylcyclohexane, 2,4- and 2,6-hexahydrotoluoylene diisocyanate and any blends of these isomers, hexahydro-1,3- and -1,4-phenylene diisocyanate, perhydro-2,4′- and -4,4′-diphenyl methane diisocyanate, 1,3- and 1,4-phenylene diisocyanate, 1,4-durene diisocyanate (DDI), 4,4′-stilbene diisocyanate, 3,3′-dimethyl-4,4′-biphenylene diisocyanate (TODI), 2,4- and 2,6-tolylene diisocyanate (TDI) and any blends of these isomers, diphenylmethane-2,4′- and -4,4′-diisocyanate (MDI) and/or naphthylene-1,4-diisocyanate (NDI).

Moreover, e.g., the following are suitable: triphenylmethane-4,4′,4″-triisocyanate, polyphenyl polymethylene polyisocyanate, which are obtained by an aniline formaldehyde condensation and a subsequent phosgenation and described, e.g., in the patent specifications GB 874,430 and GB 848,671, m- and p-isocyanatophenylsulfonyl isocyanate according to the patent specification U.S. Pat. No. 3,454,606, perchlorinated aryl polyisocyanates described in the patent specification U.S. Pat. No. 3,277,138, polyisocyanates having carbodiimide moieties described in the patent specification U.S. Pat. No. 3,152,162 and DE-A 25 04 400, 25 37 685 and 25 52 350, norbornane diisocyanates according to the patent specification U.S. Pat. No. 3,492,301, polyisocyanates having allophanate groups as described in the patent specifications GB 994,890, BE 761,626 and NL 7,102,524, polyisocyanates having isocyanurate groups as described in the patent specifications U.S. Pat. No. 3,001,9731, DE 10 22 789, 12 22 067 and 10 27 394 and in DE-A 19 29 034 and 20 04 048, polyisocyanates having urethane groups as described, e.g., in the patent specifications BE 752 261 or U.S. Pat. Nos. 3,394,164 and 3,644,457, polyisocyanates having acylated urea groups according to the patent specification DE 12 30 778, polyisocyanates having biuret groups as described in the patent specifications U.S. Pat. Nos. 3,124,605, 3,201,372 and 3,124,605 and GB 889,050, polyisocyanates produced by telomerization reactions as described in the patent specification U.S. Pat. No. 3,654,106, polyisocyanates having ester groups mentioned in the patent specifications GB 965,474 and 1,072,956, U.S. Pat. No. 3,567,763 and DE 12 31 688, conversion products of the above-mentioned isocyanates with acetates according to the patent specification DE 10 72 385 and polyisocyanates containing polymeric fatty esters according to the patent specification U.S. Pat. No. 3,455,883.

It is also possible to use the isocyanate group-containing distillation residues obtained in the technical isocyanate production optionally dissolved in one or more of the above-mentioned polyisocyanates. Moreover, it is possible to use any mixture of the above-mentioned polyisocyanates.

The technically easily obtainable polyisocyanates, e.g., 2,4- and 2,6-tolylene diisocyanate and any mixture of these isomers (“TDI”), 4,4′-diphenylmethane diisocyanate, 2,4′-diphenylmethane diisocyanate, 2,2′-diphenylmethane diisocyanate and polyphenyl polymethylene polyisocyanate manufactured by the aniline formaldehyde condensation and a subsequent phosgenation (“raw MDI”) and polyisocyanates containing carbodiimide groups, uretoimine groups, urethane groups, allophanate groups, isocyanurate groups, urea groups or biuret groups (“modified polyisocyanates”), in particular those modified polyisocyanates derived from 2,4- and/or 2,6-tolylene diisocyanate or 4,4′- and/or 2,4′-diphenylmethane diisocyanate are preferably used. Naphtylene-1,5-diisocyanate and blends of the mentioned polyisocyanates are also well suited.

Acrylates are preferably selected from the group of 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, neopentyl glycol hydroxypivalate di(meth)acrylate, dicyclopentanyl di(meth)acrylate, dicyclopentenyl-modified caprolactam di(meth)acrylate, ethylen oxide-modified phosphoric acid di(meth)acrylate, allyl group-modified cyclohexyl di(meth)acrylate, isocyanurate di(meth)acrylate, trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl) isocyanurate, propionic acid-modified dipentaerythritol penta(meth)acrylate, dipentaerythritol hexa(meth)acrylate, caprolactam-modified dipentaerythritol hexa(meth)acrylate, (meth)acrylate esters, a monofunctional (meth)acrylate, such as, e.g., methyl(meth)acrylate, ethyl(meth)acrylate, isopropyl(meth)acrylate, 2-ethylhexyl(meth)acrylate butyl(meth)acrylate, cyclohexyl(meth)acrylate, tetrahydrofurfuryl(meth)acrylate, 2-hydroxyethyl(meth)acrylate, 2-hydroxypropyl(meth)acrylate, polyethyleneglycolmono(meth)acrylate, methoxypolyethyleneglycolmono(meth)acrylate, polypropyleneglycolmono(meth)acrylate, polyethyleneglycol-polypropyleneglycolmono(meth)acrylate, polyethyleneglycol-polytetramethyleneglycolmono(meth)acrylate und glycidyl(meth)acrylate; a difunctional (meth)acrylate such as, e.g., ethyleneglycoldi(meth)acrylate, diethyleneglycoldi(meth)acrylate, triethyleneglycoldi(meth)acrylate, tetraethyleneglycoldi(meth)acrylate, polyethyleneglycoldi(meth)acrylate, polypropyleneglycoldi(meth)acrylate, neopentylglycoldi(meth)acrylate, allyl(meth)acrylate, bisphenol-A-di(meth)acrylate, ethylene oxide-modified bisphenol-A-di(meth)acrylate, polyethylene oxide-modified bisphenol-A-di(meth)acrylate, ethylene oxide-modified bisphenol-S-di(meth)acrylate, bisphenol-S-di(meth)acrylate, 1,4-butanedioldi(meth)acrylate, und 1,3-butyleneglycol-di(meth)acrylate; and tri- and higher functional (meth)acrylates, such as, e.g., trimethylolpropane tri(meth)acrylate, glyceroltri(meth)acrylate, pentaerythritol-tri(meth)acrylate, pentaerythritoltetra(meth)acrylate, ethylene-modified trimethylolpropanetri(meth)acrylate, dipentaerythritolhexa(meth)acrylate, 2-hydroxyethyl(meth)acrylate, 2-hydroxypropyl(meth)acrylate, isobutyl(meth)acrylate, t-butyl(meth)acrylate, 2-ethylhexyl(meth)acrylate, stearylacrylate, 2-ethylhexylcarbitolacrylate, omegacarboxypolycaprolactam monoacrylate, acryloyloxyethylic acid, acrylic acid dimer, lauryl(meth)acrylate, 2-methoxyethyl acrylate, butoxyethyl acrylate, ethoxyethoxyethyl acrylate, methoxytriethylene glycol acrylate, methoxypolyethylene glycol acrylate, stearyl(meth)acrylate, cyclohexyl (meth)acrylate, tetrahydrofurfuryl(meth)acrylate, n-vinyl-2-pyrrolidone, isobornyl (meth)acrylate, dicyclopentenyl acrylate, benzyl acrylate, phenyl glycidyl ether epoxyacrylate, phenoxyethyl(meth)acrylate, phenoxy(poly)ethylene glycol acrylate, nonylphenol ethoxylated acrylate, acryloyloxyethylphthalic acid, tribromophenyl acrylate, tribromophenol ethoxylated (meth)acrylate, methyl methacrylate, tribromophenyl methacrylate, methacryloxyethylic acid, methacryloyloxyethylmaleic acid, methacryloyloxyethylhexahydrophthalic acid, methacryloyloxyethylphthalic acid, polyethylene glycol (meth)acrylate, polypropylene glycol (meth)acrylate, beta-carboxyethyl acrylate, n-methylol acrylamide, n-methoxymethyl acrylamide, n-ethoxymethyl acrylamide, N-n-butoxymethyl acrylamide, t-butyl acrylamide sulfonic acid, vinyl stearate, n-methyl acrylamide, n-dimethyl acrylamide, n-dimethylaminoethyl(meth)acrylate, n-dimethylaminopropyl acrylamide, acryloyl morpholine, glycidyl methacrylate, n-butyl methacrylate, ethyl methacrylate, allyl methacrylate, cetyl methacrylate, pentadecyl methacrylate, methoxypolyethylene glycol (meth)acrylate, diethylaminoethyl(meth)acrylate, methacryloyloxyethylsuccinic acid, hexanediol diacrylate, neopentyl glycol diacrylate, triethylene glycol diacrylate, polyethylene glycol diacrylate, polypropylene glycol diacrylate, pentaerythritol diacrylate monostearate, glycol diacrylate, 2-hydroxyethylmethacryloyl phosphate, bisphenol-A-ethylene glycol adduct acrylate, bisphenol-F-ethylene glycol adduct acrylate, tricyclodecanemethanol diacrylate, trishydroxyethyl isocyanurate diacrylate, 2-hydroxy-1-acryloxy-3-methacryloxypropane, trimethylolpropane triacrylate, trimethylolpropane ethylen glycol adduct triacrylate, trimethylolpropane propylene glycol adduct triacrylate, pentaerythritol triacrylate, trisacryloyloxyethyl phosphate, trishydroxyethyl isocyanurate triacrylate, modified epsilon-caprolactam triacrylate, trimethylolpropane ethoxy triacrylate, glycerol propylene glycol adduct triacrylate, pentaerythritol tetraacrylate, pentaerythritol ethylene glycol adduct tetraacrylate, ditrimethylolpropane tetraacrylate, dipentaerythritol hexa(penta)acrylate, dipentaerythritolmonohydroxy pentaacrylate, urethane acrylate, epoxyacrylate, polyesteracrylate, and/or unsaturated polyesteracrylates.

The photoinitiator may preferably be selected from the group of benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)-phenyl]-2-morpholinopropane-1-one, 4-(2-hydroxyethoxy)phenyl-2-hydroxy-2-propyl ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenon dimethyl ketal and/or p-dimethylamine benzoate.

Advantageously, the sun protection film of the invention has functional layer(s) free from silicone resin to prevent the surface-active substances that are often contained in silicone resins to contact the surface of the sun protection film and thus impair the properties of the sun protection film.

Preferably, the functional layer(s) containing infrared radiation absorbing materials is (are) free from hexaborides since the use of hexaborides is disadvantageous if only for the reason that the common manufacturing process of admixing oxides would have to be extended by another process step. Moreover, with the use of borides it has to be expected like with all boron compounds that in a combustion toxic compounds attacking the central nervous system are formed. Already for this reason it is advantageous not to use hexaborides in the sun protection film according to the invention.

Preferably, the matrix of the functional layer is not made of a photocationically formed polymer. On the contrary, it is advantageous that the matrix of the functional layer be made of a polymer which is formed, e.g., anionically or by free radicals. Making the polymer layer by drying a polymer solution is equally preferred.

Advantageously, the functional layer(s) contain(s) an infrared radiation absorbing material in an amount of from 10 to 60% by weight, in particular of from 20 to 40% by weight.

Preferably, the functional layer(s) contain(s) less than 60% by weight of ATO, in particular less than 40% by weight of ATO since this enables a higher transparency or light transmission to be achieved and also the functional layer to be manufactured at much lower cost.

Preferably, the functional layer(s) contain(s) either an organic infrared radiation absorbing material or an inorganic infrared radiation absorbing material.

Preferably, the functional layer(s) has (have) a thickness in the range of from 100 nm to 50 μm, in particular of from 0.2 to 20 μm.

Preferably, the functional layer(s) may be produced either solvent-based or solvent-free. The solvent-free method has the particular advantage to be environmentally more compatible.

If said at least one functional layer contains metals and/or metal compounds and/or composites thereof, the metal is preferably selected from the group consisting of Sn, Ti, Si, Zn, Zr, Fe, Al, Cr, Co, Ce, In, Ni, Ag, Cu, Pt, Nn, Ta, W, V or Mo. Preferably, the metal compounds are oxides, nitrides, carbides, oxinitrides and/or sulfides of said metals.

Preferably, the sun protection film has one outer functional layer facing away from the glazing having a pencil hardness of at least 3H, especially preferred of at least 4H. Said outer functional layer is preferably designed as a scratch protection layer. If the outer functional layer is designed as a scratch protection layer, it may preferably be made from polymers of the above-mentioned acrylates or from silicon compounds or mixtures thereof selected from tetramethoxysilane, tetraethoxysilane, tetra-n-propoxysilane, tetraisopropoxysilane, tetra-n-butoxysilane, tetraisobutoxysilane, tetra-secbutoxysilane, tetra-tert-butoxysilane, trimethoxysilane hydride, triethoxysilane hydride, tripropoxysilane hydride, methyltrimethoxysilane, methyltriethoxysilane, methyltripropoxysilane, methyltriisopropoxysilane, ethyltrimethoxysilane, ethyltriethoxysilane, propyltriethoxysilane, butyltrimethoxysilane, phenyltrimethoxysilane, phenyltriethoxysilane, gamma-glycidoxypropyltrimethoxysilane, gamma-acryloyloxypropyltrimethoxysilane, gamma-methacryloyloxypropyltrimethoxysilane, dimethyldimethoxysilane, methylphenyldimethoxysilane, vinyltrimethoxysilane, vinyltriethoxysilane, divinyidimethoxysilane and divinyidiethoxysilane aminopropyltriethoxysilane.

Infrared radiation absorbing materials within the meaning of the invention may be either organic or inorganic. Generally, infrared radiation absorbing materials within the meaning of the invention are materials having a molar extinction coefficient of at least 1.5 l·mol⁻¹·cm⁻¹ in a wavelength region of from 700 to 35,000 nm at least two of the wavelengths of 1000 nm, 1500 nm, 2000 nm and 3500 nm. Especially preferred, the infrared absorbing material has an absorption peak in a region of from 900 to 1000 nm. Thus, already the infrared radiation absorbing material may provide a slight tint. As organic infrared radiation absorbing material a material selected from the group of phthalocyanines, naphthalocyanines, anthraquinone, cyanine compounds, squalylium compounds, thiol nickel complex compounds, triallylmethane, naphthoquinone, anthraquinones and amine compounds such as N,N,N′,N′tetrakis(p-di-n-butylaminophenyl)-p-phenylenediaminium perchlorate, phenylenediaminium chlorate, phenylenediaminium hexafluoroantimonate, phenylenediaminium fluoroborate, phenylenediaminium fluorate and phenylenediaminum perchlorate is preferably used. As inorganic infrared radiation absorbing material a material selected from the group of the metal compounds of Sn, Ti, Si, Zn, Zr, Fe, Al, Cr, Co, Ce, In, Ni, Ag, Cu, Pt, Nn, Ta, W, V and Mo is preferably used. The metal compounds are preferably oxides, nitrides, carbides, oxinitrides and/or sulfides of said metals. Especially preferred are ITO (indium tin oxide), ATO (antimony tin oxide), SnO₂, TiO₂, SiO₂, ZrO₂, ZnO, Fe₂O₃, Al₂O₃, FeO, Cr₂O₃, CO₂O₃, CeO₂, In₂O₃, NiO, MnO and CuO. In particular preferred infrared radiation absorbing materials are ITO, ATO, TiN or zinc oxide. An especially advantageous infrared radiation absorbing material is ITO.

UV absorbing materials within the meaning of the invention may be either organic or inorganic. Generally, UV absorbing materials within the meaning of the invention are those materials having a molar extinction coefficient of at least 1.5 l·mol⁻¹·cm⁻¹ in a wavelength region of from 100 to 250 nm at the wavelengths of 150 nm and 200 nm. Inorganic UV absorbing materials such as, e.g., ITO and/or ATO are preferred. The organic UV absorbing materials selected from the group of benzotriazole derivatives such as 2-(2′-hydroxy-5′-methylphenyl)benzotriazole, 2-(2′-hydroxy-3′,5′-ditert-butylphenyl)benzotriazole, 2-(2′-hydroxy-3′-tert-butyl-5′-methylphenyl)-5-chlorobenzotriazole, 2-(2′-hydroxy-3′,5′-ditert-butylphenyl)-5-chlorobenzotriazole and 2-(2′-hydroxy-3′,5′-ditertamylphenyl)benzotriazole, and benzophenone derivatives such as 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone and 2-hydroxy-4-methoxy-5-sulfobenzophenone, and cyanoacrylate derivatives such as 2-ethylhexyl-2-cyano-3,3′-diphenylacrylate and ethyl-2-cyano-3,3′-diphenylacrylate are equally preferred.

The particle size of the inorganic infrared radiation absorbing materials is preferably in a range of from 1 to 20,000 nm and especially preferred in a range of from 1 to 2000 nm. It is highly preferred that the particle size of said infrared radiation absorbing materials be up to 100 nm. If the functional layer contains also metal and oxides, the metal may be incorporated by co-sputtering the metal and the oxides into the layer.

Advantageously, the functional layer has an air and/or oxygen permeability J_{LS} of up to 7.64×10¹⁹ kg·m/(m²·s·Pa) at 25° C. and/or a water permeability J_{W} of up to 1.1×10¹⁵ kg·m/(m²·s·Pa) at 25° C. This is advantageous in that also natural substrates such as wood may be provided with the film and thus protected from humidity and/or aggressive exhaust gases.

When measuring the water permeability, the water activity A_{W} is in a range of from 0.4 to 0.9.

### Supporting Film

The supporting film of the invention may advantageously also contain an infrared radiation absorbing material. Hence, the functional layer(s) may be designed thinner or loaded with a lower amount of particulate infrared radiation absorbing material in order to minimize the light-scattering behavior.

Preferably, the supporting film mainly consists of transparent thermoplastics. A material selected from the group of polyethylene and polypropylene, vinyl chloride resins, styrene resins, ABS resins, polyvinyl alcohol, acryl resins, acrylonitrile styrene resins, vinylidene chloride resins, AAS resins, AES resins, polyurethane resins, polyvinyl butyral resins, poly-4-methylpentene-1 resins, polybutene-1 resins, vinylidene fluoride resins, vinyl fluoride resins, fluorocarbon resins, polycarbonate resins, polyamide resins, polyacetal resins, polyphenylene oxide resins, polyester resins such as polybutylene terephthalate and polyethylene terephthalate, polyphenylene sulfide resins, polyimide resins, polysulfone resins and polyallylate resins is preferably suited. Here, PET, PC, PMMA, polyethylene, polypropylene, polycarbonate, acryl polymer, methacryl polymer, polyvinylchloride, polyester, polyamides, epoxides and phenolic resin or also PE or PP and (poly)cyclic polyolefins, polyacetates, polyacetals, polyamides are especially suited. Blends or corresponding copolymerizates may also be used. Especially preferred the film consists of PET. It is especially advantageous if one or several of properties i) to vi) are realized also in the supporting film.

If the supporting film is metallized, the layer thickness of the metallization layer(s) is (are each) in a range of from 1 to 100 nm, in particular from 5 to 50 nm. In the selection of the metallization layer, the color and/or reflection thereof is critical. Especially preferably Ti, Fe, Ni, Cr, a noble metal, most preferably aluminium is used as the metal for the metallization layer. However, especially preferred none of the layers is metallized to avoid disturbing light reflections on the façade.

Advantageously, the width of the supporting film exceeds 155 cm, especially preferred 175 cm. Advantageously, the layer thickness of the supporting layer may be in a range of from 5 to 200 μm. The sun protection film according to the invention has a total of preferably at least two, especially preferably two supporting films. If at least two supporting films are present, the supporting film closest to the substrate preferably has a layer thickness of from 0.8 to 1.2 mm, whereas the supporting films more remote from the substrate have a layer thickness in the range of from 0.1 to 0.7 mm.

### Adhesive Layer

Advantageously, the thickness of the adhesive layer is a multiple of the roughness of the adjacent layers. Especially preferred, the layer thickness of the adhesive layer(s) is (are each) in a range of from 5 nm to 50 μm. Advantageously, the adhesive layer may also comprise an IR absorbing material, in particular ATO. Preferably, the adhesive layer consists of a material selected from the group of pressure sensitive adhesives, heat sensitive adhesives and/or humidity sensitive adhesives.

In particular, natural rubber, synthetic rubber, acryl, polyvinyl ether, urethane or silicone pressure sensitive adhesives, in particular styrene butadiene rubber, polyisobutylene rubber, isobutylene isoprene rubber, isoprene rubber, styrene isoprene block copolymer, styrene butadiene block copolymer, styrene ethylene butylene block copolymer and ethylene vinyl acetate elastomer, copolymers of acrylic acid, methyl acrylate, ethyl acrylate, propyl acrylate, butyl acrylate, 2-ethylhexyl acrylate, ethyl methacrylate, butyl methacrylate and acrylonitrile, polyvinyl ether, polyvinyl isobutyl ether and dimethylpolysiloxanes are suited as pressure sensitive adhesives (PSA).

Ethylene-vinyl acetate copolymers, ethylene-acrylic ester copolymers, phenoxy resins, nylon 11, nylon 12, saturated polyesters, coumarone indene resins, styrene-isoprene-styrene copolymer rubber, styrenebutadiene-styrene copolymer rubber, polyethylene resins and polyurethane resins may preferably be used as heat sensitive adhesives.

For example, polyacrylamide, polyacrylic acid, polyacrylate esters, polyvinyl alcohol, polyvinyl ether, cellulose derivatives and starch may be used as humidity sensitive adhesives.

Preferably, the material for the adhesive layer is one of the above-mentioned materials of a blend thereof. Advantageously, said material may additionally comprise fillers and other auxiliaries.

Especially preferred are pressure sensitive adhesives (PSA). The adhesive layer, which is preferably applied to the outer side of the sun protection film according to the invention and facing the substrate, may advantageously be a so-called of assembly adhesive layer, whereas the other adhesive layers optionally existing in the sun protection film are advantageously so-called laminate adhesive layers. In order take into consideration the special requirements on these various adhesive layers, the assembly adhesive layers preferably consist of another material than the laminate adhesive layers. Thus, it is important for the assembly adhesive layer to be especially well bondable to the material of the substrate which may differ from the material of the supporting film(s).

### Optical and Thermal Properties

Preferably, the energy transmission g of the sun protection film of the present invention is up to 0.85 according to DIN 4108-3 since this can ensure that the sun protection film can efficiently shield in particular heat energy.

As defined above, the selectivity number of the sun protection film is preferably at least 1.1. This ensures that with a high light transmission the energy transmission is especially low at the same time.

Preferably, the luminous reflectance is up to 15%, in particular up to 10%. This enables the sun protection film of the invention to be used also in applications where luminous reflectances are unwanted or even not permitted, such as, e.g., the use in windshields of passenger cars. In order to achieve said low luminous reflectance, the sun protection film does advantageously not have a metal layer.

The light transmission of the sun protection film according to the invention is at least 70%, in particular at least 80% in the wavelength region of from 400 nm to 700 nm. Thus, contrary to the known sun protection films the sun protection film according to the invention may also be used in applications where a high light transmission is necessary or desired.

Preferably, the sun protection film has a haze value in a range of from 0.1 to 4%. This haze value does not change significantly when varying the layer thickness of the functional layer containing the infrared absorbing material.

Especially preferred, the sun protection film may be colored blue or green. At least one colorant may be contained in the functional layer, the adhesive layer and/or the supporting film. The infrared radiation absorbing material may also be colored with the colorant. Said colorant may be contained in these layers in an amount in a range of from 0.1 to 10% by weight, especially preferred in a range of from 0.2 to 1% by weight in at least one of these layers. The colorant may be selected from the group of pigments, synthetic colorants, natural colorants and/or mixtures thereof. Natural colorants are advantageously selected from the group of anthocyans, alizarin, betalains, haematoxylon, chlorophyll, cochineal, curcuma, hemoglobin, indigo, kermes, madder, litmus, annatto, orcein, purple of the ancients and/or safflower. Synthetic colorants are advantageously selected from the group of phthalocyanine colorants, naphthalocyanines, aminophenyl derivatives, benzoquinone derivatives, aniline blue, aniline black, anthracene blue, Bismarck brown, chrysoidin, Ciba blue, fuchsin, Hydron blue (Hydron® blue R, 3%, G), immedial black (Immedial® and immedial light dyes), Congo red, crystal violet, malachite green, methylene blue, methyl orange, methyl violet, Variamin® blue and/or Victoria blue. Nanoscale pigments are advantageously selected from the group of metal powders, white pigments such as titanium white (titanium dioxide), white lead, zinc white, lithopones, antimony white, antimony white, black pigments such as carbon black, iron oxide black, manganese black and cobalt black and antimony black, colored pigments such as lead chromate, minium, zinc yellow, zinc green, cadmium red, cobalt blue, Berlin blue, ultramarine, manganese violet, cadmium yellow, Schweinfurt green, molybdate orange and molybdate red, chrome orange and red, iron oxide red, chrome oxide green and/or strontium yellow. Advantageously, an organic absorber, an inorganic absorber or mixtures thereof are used. Furthermore, it is advantageous if the infrared absorber absorbs an especially small amount of visible light.

### EMBODIMENTS

### Comparative Example 1

### ITO Coating

Forty-five grams of a dispersion of Sn doted indium oxide with a particle size below 100 nm in toluene with a solids content of 40% by weight were mixed with 55 g of a PU paint with a solids content of 24% by weight. After mixing for 5 min a clear dispersion was formed.

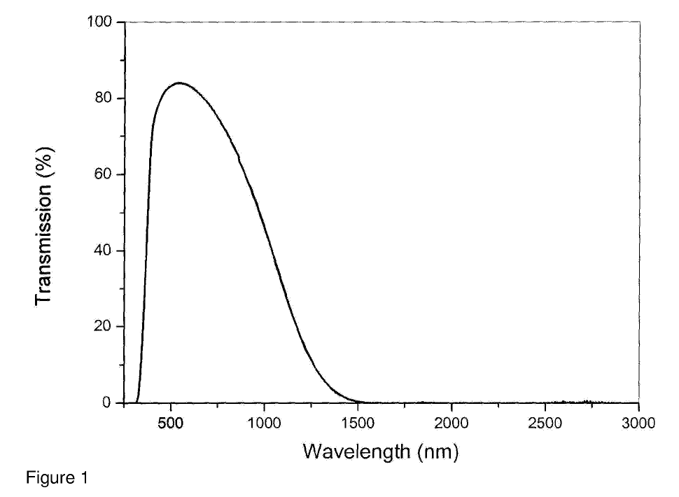

The paint was applied to a PET film 50 μm thick using a wire-wound coating bar and dried at 80° C. for 30 min. The resulting particle content in the layer was 9 g/m², the proportion of particles in the total mass of the layer was 57% by weight. FIG. 1 shows the measured transmission curve. The transmission at a wavelength of 1000 nm in the near infrared range is markedly above 50% of the maximum transmission of the sun protection film.

### Example 1

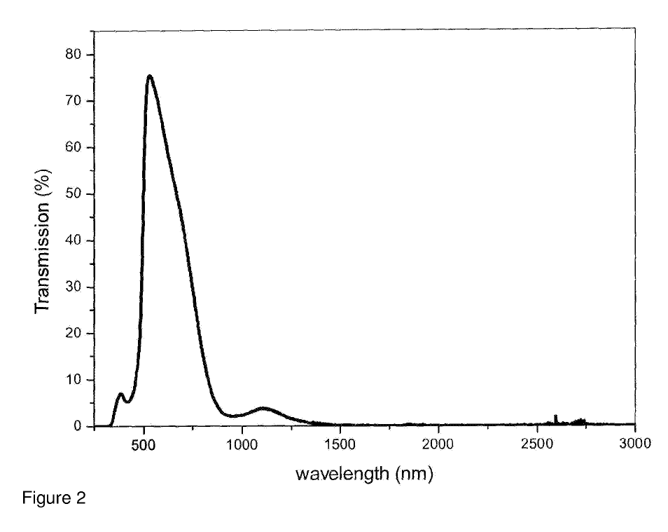

Example 1 was performed like comparative example 1, however, a 2:3 mixture of N,N,N′,N′-tetrakis-(p-di-n-butylaminophenyl)-p-phenylenediamine and N,N,N′,N′-tetrakis-(p-di-n-butylaminophenyl)-p-benzoquinonebis(ammoniumhexafluoro antimonate) was added to the coating solution. In the example the total amount of the mixture was 7.5% by weight based on ITO. FIG. 2 shows the corresponding transmission curve. This layer was greenish colored. The transmission at a wavelength of 1000 nm in the near infrared region is markedly below 50% of the maximum transmission of the sun protection film.

### Comparative Example 2

### ATO Coating

Forty-five grams of a dispersion of antimony doted tin oxide with a particle size below 100 nm in toluene with a solids content of 20% by weight were mixed with 55 g of a PU paint with a solids content of 24% by weight. After mixing for 5 min a clear dispersion was formed.

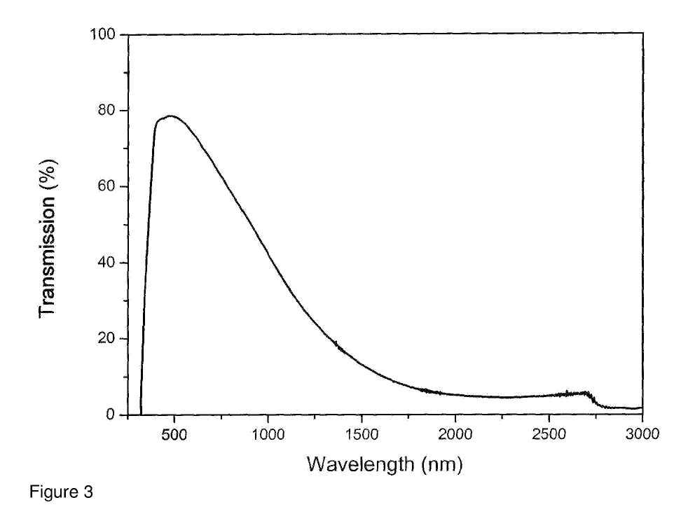

The paint was applied to a PET film 50 μm thick using a wire-wound coating bar and dried at 80° C. for 30 min. The resulting particle content in the layer was 4.5 g/m². FIG. 3 shows the measured transmission curve. The transmission at a wavelength of 1000 nm in the near infrared range is markedly above 50% of the maximum transmission of the sun protection film.

### Example 2

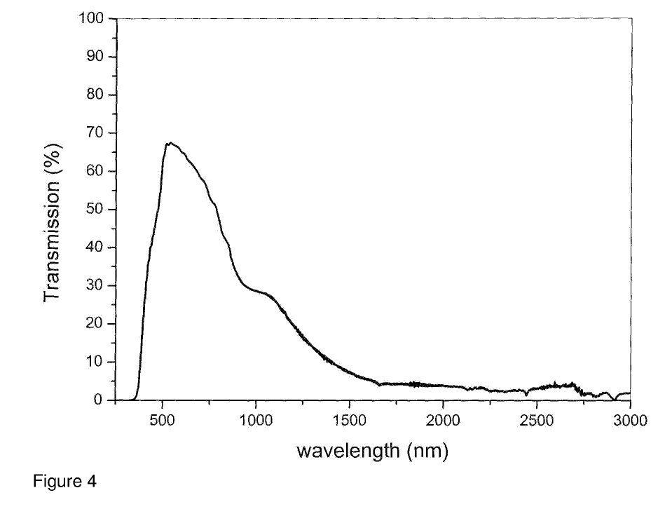

Example 2 was performed like comparative example 2, however, 10% by weight (based on ATO) of a 2:3 mixture of N,N,N′,N′-tetrakis(p-di-n-butylaminophenyl)-p-phenylenediamine and N,N,N′,N′-tetrakis-(p-di-n-butylaminophenyl)-p-benzoquinonebis(ammoniumhexafluoro antimonate) was added. FIG. 4 shows the transmission spectrum. The transmission at a wavelength of 1000 nm in the near infrared region is markedly below 50% of the maximum transmission of the sun protection film.

1. A sun protection film for transparent or translucent glazings having a transmission at a wavelength of 1000 nm of up to 50% of the maximum value of the transmission in the wavelength range below 1000 nm comprising:
a) at least one metallized or non-metallized supporting film 0.1 to 500 μm thick which planarly contacts at least one adhesive layer and
b) at least one functional layer which contains an organic infrared radiation absorbing material on at least one main surface of the supporting film and which contains metal, is metallic or metal-free and
i) contains pigment and/or colorants,
ii) contains at least one UV radiation absorbing material and/or
iii) has a pencil hardness of at least 3H.

2. The sun protection film according to claim 1 comprising at least two functional layers, wherein each functional layer differs from the adjacent functional layer by at least one property i) to iii) and only one of these layers contains an organic infrared radiation absorbing material.

3. The sun protection film according to claim 1 comprising an adhesive layer for the mounting of the support film.

4. The sun protection film according to claim 1 characterized in that the outer functional layer facing away from the glazing has a pencil hardness of at least 3H.

5. The sun protection film according to claim 1 characterized in that the functional layer(s) is (are) free from silicone resins.

6. The sun protection film according to claim 1 characterized in that the functional layer containing infrared radiation absorbing materials is free from hexaborides.

7. The sun protection film according to claim 1 characterized in that the matrix of the functional layers does not consist of a photocationically formed polymer.

8. The sun protection film according to claim 1 characterized in that the functional layer(s) contain(s) less than 60% by weight of particles, in particular ATO particles.

9. The sun protection film according to claim 1 characterized in that the functional layer(s) contain(s) either an organic infrared radiation absorbing material or an inorganic infrared radiation absorbing material.

10. The sun protection film according to claim 1 characterized in that it does not have a separate primer layer.

11. The sun protection film according to claim 1 characterized in that the degree of energy transmission g is up to 0.85.

12. The sun protection film according to claim 1 characterized in that the selectivity number is at least 1.1.

13. The sun protection film according to claim 1 characterized in that the light reflection is up to 15%.

14. The sun protection film according to claim 1 characterized in that the light transmission in a wavelength region of 400 nm to 700 nm is at least 70%.

15. The sun protection film according to claim 1 characterized in that the supporting film(s) contain(s) an infrared radiation absorbing material.

16. The sun protection film according to claim 1 characterized in that the adhesive layer(s) contain(s) an infrared radiation absorbing material.

17. The sun protection film according to claim 1 characterized in that the functional layer(s) contain(s) an infrared radiation absorbing material.

18. The sun protection film according to claim 1 characterized in that the light reflection is up to 15%, in particular up to 10%.

19. The sun protection film according to claim 1 characterized in that the light transmission in a wavelength region of 400 nm to 700 nm is at least 70%, in particular at least 80%.
